(19) United States
(12) Patent Application Publication
(10) Pub. No.: US 2026/0299605 A1
(43) Pub. Date: Oct. 1, 2026

(54) CONTROL DEVICE AND CONTROL METHOD

(71) Applicant: HONDA MOTOR CO., LTD., Tokyo (JP)

(72) Inventor: Takaaki Nishida, Wako-shi (JP)

(21) Appl. No.: 19/564,257

(22) Filed: Mar. 12, 2026

(30) Foreign Application Priority Data
Mar. 25, 2025 (JP) 2025-049247

(51) Int. Cl. G05D 1/65; A01D 34/00; A01D 41/02; A01D 41/127; A01D 101/00; G05D 105/15; G05D 107/20

(52) U.S. Cl. CPC G05D 1/65; A01D 34/008; A01D 41/02; A01D 41/127; A01D 2101/00; G05D 2105/15; G05D 2107/23

(57) ABSTRACT

A control device includes: an information acquisition unit that acquires information indicating a distance between a working machine and a target point; and a travel control unit that limits an upper limit of a traveling speed of the working machine according to the distance while controlling the working machine to cause the working machine to travel toward the target point.

### CROSS-REFERENCE TO RELATED APPLICATIONS

This application is based upon and claims the benefit of priority from Japanese Patent Application No. 2025-049247 filed on Mar. 25, 2025, the contents of which are incorporated herein by reference.

### BACKGROUND OF THE INVENTION

### Field of the Invention

The present disclosure relates to a control device and a control method.

### Description of the Related Art

JP S59-092900 A discloses a decelerating and stopping device for a working machine.

### SUMMARY OF THE INVENTION

Recently, there has been a long awaited need for a more satisfactory technology in relation to a traveling control for a working machine that travels along a preset route.

The present disclosure has the object of solving the above-described problem.

A first aspect of the present disclosure is characterized by a control device comprising: an information acquisition unit configured to acquire information indicating a distance between a working machine and a target point; and a travel control unit configured to limit an upper limit of a traveling speed of the working machine according to the distance while controlling the working machine to cause the working machine to travel toward the target point.

A second aspect of the present disclosure is characterized by a control method comprising: an acquisition step of acquiring information indicating a distance between a working machine and a target point; and a travel control step of limiting an upper limit of a traveling speed of the working machine according to the distance while controlling the working machine to cause the working machine to travel toward the target point.

According to the present disclosure, a control device and a control method are provided that are capable of appropriately limiting the traveling speed of a working machine in accordance with a distance between the working machine and a target point.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a diagram showing a working machine according to an embodiment of the present disclosure;

FIG. 2 is a block diagram of a control device provided in the working machine of FIG. 1;

FIG. 3 is a graph schematically illustrating an expected behavior of the working machine; and

FIG. 4 is a flowchart of a control method according to the embodiment.

### DETAILED DESCRIPTION OF THE INVENTION

A working machine that travels along a preset route is, for example, an agricultural working machine such as a lawn mower or a combine harvester. These working machines can execute predetermined work such as mowing while autonomously traveling along a route (performing route following). In addition, a plurality of target points along the route are set. The route is divided by the plurality of target points. The target points include, for example, a stop point, a turnabout point, and a turning point. The working machine sequentially tracks the plurality of target points along the route.

Incidentally, from the viewpoint of realizing route following with good accuracy while causing the working machine to travel smoothly, it is preferable to appropriately control the traveling speed of the working machine traveling toward the target point. For example, it is preferable that the working machine be appropriately decelerated so that the working machine can be stopped exactly at the stop point. Further, it is preferable that the working machine be appropriately decelerated to such an extent that the working machine can smoothly perform a turn operation such as a K-turn at the turnabout point, for example. Furthermore, it is preferable that the working machine be appropriately decelerated to such an extent that the working machine can smoothly perform a turning operation such as pivot turn at the turning point, for example.

With the above preliminary description in mind, hereinafter, an embodiment of the present disclosure will be described. Note that a program (a computer program, computer software) in the following description is also referred to as a computer program product. The computer program product is not limited to a program stored in a storage medium (recording medium), but includes a program that is transmitted, distributed, or downloaded via a network such as the Internet.

### Embodiments

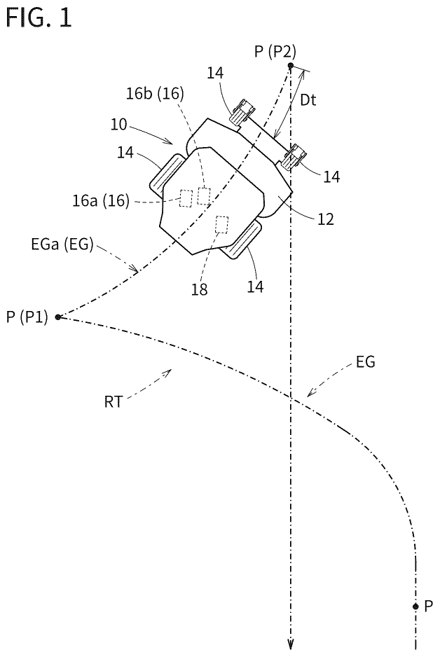

FIG. 1 is a diagram showing a working machine 10 according to an embodiment of the present disclosure.

The working machine 10 is an agricultural working machine such as a lawn mower or a combine harvester. The working machine 10 autonomously travels along a route RT determined in advance (performs route following) in a working area such as a lawn or a farmland. The working machine 10 may be an unmanned working machine or a manned working machine. The manned working machine may be provided with a seat such as a steering seat. The manned working machine may be steered as necessary by an occupant who is seated on the seat.

The working machine 10 includes a vehicle body 12 capable of traveling in a working area. The vehicle body 12 is provided with a plurality of wheels 14. Although not shown, the vehicle body 12 is further provided with a drive source such as an internal combustion engine or an electric motor, and a working tool used for carrying out predetermined work. The vehicle body 12 travels by means of a driving force obtained from the drive source. The working tool is, for example, a cutter for mowing grass or the like.

The vehicle body 12 is further provided with a plurality of sensors 16. The plurality of sensors 16 include a vehicle speed sensor 16a and a positioning sensor 16b. The vehicle speed sensor 16a is a sensor 16 that outputs a detection signal corresponding to a traveling speed Vc of the working machine 10. The positioning sensor 16b is a sensor 16 that detects the position (displacement) of the working machine 10. The positioning sensor 16b may include a receiver that receives positioning results (positioning signals) of the working machine 10 from a positioning system such as a satellite positioning system.

The working machine 10 further includes a control device 18. The control device 18 is an electronic device that controls the vehicle body 12. For example, a computer such as an electronic control unit (ECU) is included in the control device 18.

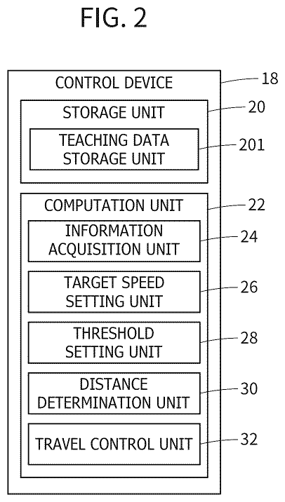

FIG. 2 is a block diagram of the control device 18 provided in the working machine 10 of FIG. 1.

The control device 18 includes a storage unit 20 and a computation unit 22.

The storage unit 20 includes one or more memories. The storage unit 20 includes a non-volatile memory such as a read only memory (ROM), a flash memory, or a magnetic disk. The non-volatile memory is a storage medium that non-transitorily stores programs, tables, maps, and the like. At least part of the storage unit 20 may be realized by a storage medium such as a universal serial bus (USB) memory, a memory card, or an optical disk. The storage unit 20 may include a volatile memory such as a random access memory (RAM).

The storage unit 20 includes a teaching data storage unit 201 in which teaching data is stored. The teaching data includes various types of information that are taught to the working machine 10 in advance by a user or the like of the working machine 10.

For example, route information is included in the teaching data. The route information is information indicating a route RT to be followed by the working machine 10, and a plurality of target points P (one or more target points P) that are set along the route RT. Although not illustrated in the drawings, the plurality of target points P include a stop position, a turnabout position, a turning position, and the like. The stop position is a position at which the working machine 10 is stopped (temporarily stopped). The turnabout position is a position at which the working machine 10 is made to perform a turn operation such as a K-turn. The turning position is a position at which the working machine 10 is caused to perform a turning operation such as pivot turn.

Further, edge speed information is further included in the teaching data. The route RT is divided into a plurality of sections (edges EG) by a start point (not shown) of the route RT and the plurality of target points P. Two target points P adjacent to each other along the route RT define one edge EG. The edge speed information indicates an edge speed that is an allowable maximum speed of the working machine 10 on each of the plurality of edges EG.

The computation unit 22 includes processing circuitry capable of executing arithmetic processing. The processing circuitry may include one or more processors. For example, the processing circuitry may include a central processing unit (CPU), a graphics processing unit (GPU), or the like. The processing circuitry may include an integrated circuit (IC) or a discrete device.

The computation unit 22 includes an information acquisition unit 24, a target speed setting unit 26, a threshold setting unit 28, a distance determination unit 30, and a travel control unit 32. The information acquisition unit 24, the target speed setting unit 26, the threshold setting unit 28, the distance determination unit 30, and the travel control unit 32 are realized by the processing circuitry described above. For example, the information acquisition unit 24, the target speed setting unit 26, the threshold setting unit 28, the distance determination unit 30, and the travel control unit 32 are realized by the processor of the computation unit 22 executing a program stored in the storage unit 20. At least one of the IC or the discrete device described above may realize at least part of the information acquisition unit 24, the target speed setting unit 26, the threshold setting unit 28, the distance determination unit 30, and the travel control unit 32.

The information acquisition unit 24 acquires various types of information based on detection signals output from the plurality of sensors 16 described above. For example, the information acquisition unit 24 acquires vehicle speed information based on the detection signal acquired from the vehicle speed sensor 16a. The vehicle speed information is information indicating a traveling speed Vc (current traveling speed) of the working machine 10. Further, the information acquisition unit 24 acquires position information based on the detection signal (positioning signal) acquired from the positioning sensor 16b. The position information is information indicating the current position of the working machine 10.

Furthermore, the information acquisition unit 24 acquires distance information based on the route information and the position information. The distance information is information indicating a distance Dt between the working machine 10 and the target point P. The information acquisition unit 24 specifies, for example, a target point P (a second target point P2 in the example of FIG. 1) located at an end point of a current edge EGa, which is the edge EG where the working machine 10 is located, based on the route information and the position information. In other words, the information acquisition unit 24 specifies the target point P that the working machine 10 is about to reach next, based on the route information and the position information. The information acquisition unit 24 specifies the distance Dt between the working machine 10 and the target point P that the working machine 10 is about to reach next, based on the route information and the position information.

It should be noted that unless otherwise specified, the target point P in the following description is a target point P (the second target point P2 in the example of FIG. 1) that the working machine 10 is about to reach next.

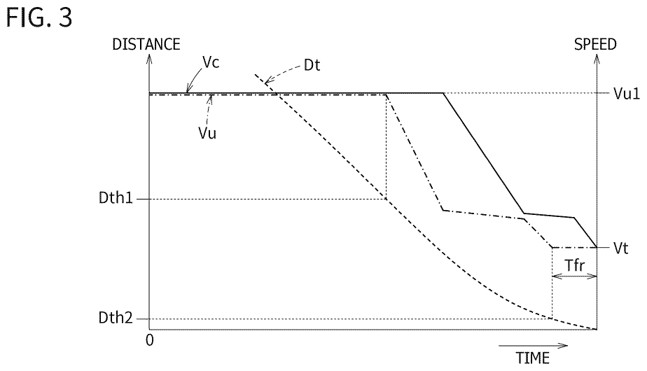

The target speed setting unit 26 sets a target speed Vt corresponding to the target point P based on the route information. The target speed Vt is a target value of the traveling speed Vc of the working machine 10 at a stage when the working machine 10 reaches the corresponding target point P (also see FIG. 3). For example, in the case where the target point P is a stop position, the target speed setting unit 26 sets the target speed Vt corresponding to the stop position to zero in order to stop the working machine 10 at the stop position.

In the case where the target point P is a turnabout position, a turning position, or the like, the target speed setting unit 26 sets the target speed Vt corresponding to the target point P so that the working machine 10 can reach the target point P and smoothly perform a turnabout operation, a turning operation, or the like. In this case, the target speed setting unit 26 may set a specific value of the target speed Vt according to the operation to be executed at the target point P. For example, in the case where a K-turn is scheduled to be executed at the target point P, the target speed setting unit 26 may set the target speed Vt according to the K-turn. The target speed Vt corresponding to the turnabout position, the turning position, or the like may be equal to or greater than zero. More specifically, the target speed Vt corresponding to the turnabout operation, the turning operation, or the like is preferably greater than zero so that the working machine 10 does not excessively decelerate, but it may be zero. A correspondence relationship between each operation such as the turnabout operation and the turning operation and the target speed Vt may be specified in advance based on experiments, simulations, and the like. In this case, the target speed setting unit 26 may set the target speed Vt based on the correspondence relationship.

The target speed setting unit 26 sets a target speed Vt (a second predetermined upper limit speed) corresponding to the target point P. Note that the target speed Vt corresponding to the target point P is lower than a first predetermined upper limit speed Vu1 on the edge EG having the target point P as its end point (Vt<Vu1). The first predetermined upper limit speed Vu1 is an upper limit traveling speed of the working machine 10 on the corresponding edge EG.

The first predetermined upper limit speed Vu1 is, for example, the edge speed described above. For example, a plurality of target points P including a first target point P1 that is a start point of the current edge EGa and a second target point P2 that is an end point of the current edge EGa are illustrated in FIG. 1. The edge speed on the current edge EGa may be the first predetermined upper limit speed Vu1 on the current edge EGa. In this case, the target speed Vt corresponding to the second target point P2 is lower than the edge speed on the current edge EGa.

The threshold setting unit 28 sets a plurality of distance thresholds Dth based on the traveling speed Vc. Each of the plurality of distance thresholds Dth is a threshold set for the distance Dt between the working machine 10 and the target point P. The threshold setting unit 28 specifies the traveling speed Vc based on the vehicle speed information acquired by the information acquisition unit 24. The threshold setting unit 28 sets the plurality of distance thresholds Dth corresponding to differences between the traveling speed Vc specified based on the vehicle speed information and the target speed Vt.

The plurality of distance thresholds Dth include a first distance threshold Dth1 and a second distance threshold Dth2. The first distance threshold Dth1 indicates a position (distance Dt) at which second travel control is started. The second travel control will be described in more detail later. The second distance threshold Dth2 indicates a position (distance Dt) at which third travel control is started. The third travel control will be described in more detail later.

The threshold setting unit 28 may set the first distance threshold Dth1 based on the following Expression (1). In Expression (1), Dth1 is the first distance threshold Dth1. Dth2 is a second distance threshold Dth2 derived by Expression (2) described later. Vc is the traveling speed Vc (current traveling speed) indicated by the vehicle speed information. Tfr is a control (response) delay time Tfr that occurs between the control device 18 and the vehicle body 12. The control delay time Tfr is estimated in advance based on experiments, simulations, and the like.

$$\begin{matrix}[ Expression 1 ] & \\ Dth 1 = Dth 2 + Vc \times Tfr & ( 1 )\end{matrix}$$

The threshold setting unit 28 may set the second distance threshold Dth2 based on the following Expression (2). In Expression (2), Dth2 and Vc conform to Expression (1). Vt is the target speed Vt, and “a” is a deceleration determined in advance. The deceleration a is determined in advance based on, for example, experiments, simulations, and the like.

$$\begin{matrix}[ Expression 2 ] & \\ Dth 2 = \vert \frac{{Vc}^{2} - {Vt}^{2}}{2 a} \vert & ( 2 )\end{matrix}$$

The distance determination unit 30 compares the distance Dt between the working machine 10 and the target point P as indicated by the distance information with the plurality of distance thresholds Dth set by the threshold setting unit 28. The distance determination unit 30 determines whether or not the distance Dt between the working machine 10 and the target point P is less than the first distance threshold Dth1 (Dt<Dth1). In the case where the distance Dt between the working machine 10 and the target point P is less than the first distance threshold Dth1, the distance determination unit 30 further determines whether or not the distance Dt is less than the second distance threshold Dth2 (Dt<Dth2). In other words, in the case where the distance Dt between the working machine 10 and the target point P is less than the first distance threshold Dth1, the distance determination unit 30 determines whether or not the distance Dt falls within a range between the first distance threshold Dth1 and the second distance threshold Dth2 (Dth2≤Dt<Dth1).

The travel control unit 32 controls the working machine 10 (the drive source of the vehicle body 12) to cause the working machine 10 to travel along the route RT. The travel control unit 32 selectively executes a plurality of travel controls in accordance with the result of the determination by the distance determination unit 30. In other words, the travel control unit 32 selectively executes the plurality of travel controls based on the distance Dt between the working machine 10 and the target point P and the plurality of distance thresholds Dth. The plurality of travel controls include first travel control, second travel control, and third travel control, which will be described below.

FIG. 3 is a graph schematically illustrating an expected behavior of the working machine 10. FIG. 3 illustrates changes in the distance Dt (the broken line) between the working machine 10 and the target point P, the upper limit speed Vu (the dash-dotted line) designated by the travel control unit 32, and the actual traveling speed Vc (the solid line) of the working machine 10 on the time axis (horizontal axis).

The first travel control is control for causing the working machine 10 to travel by setting the upper limit of the traveling speed Vc (the upper limit speed Vu) of the working machine 10 to the first predetermined upper limit speed Vu1 described above. In the case where the distance Dt between the working machine 10 and the target point P is equal to or greater than the first distance threshold Dth1, the travel control unit 32 executes the first travel control. In the case where the first travel control is executed, the travel control unit 32 may control the working machine 10 so that the traveling speed Vc of the working machine 10 becomes the first predetermined upper limit speed Vu1. Further, in the case where the first travel control is executed, the travel control unit 32 may accelerate or decelerate the working machine 10 within a range equal to or less than the first predetermined upper limit speed Vu1. For example, the travel control unit 32 may accelerate the working machine 10 within the range equal to or less than the first predetermined upper limit speed Vu1 in accordance with the accelerator operation by the occupant described above.

The second travel control is control for lowering the upper limit speed Vu to the target speed Vt (the second predetermined upper limit speed). In the case where the distance Dt between the working machine 10 and the target point P falls within the range between the first distance threshold Dth1 and the second distance threshold Dth2, the travel control unit 32 executes the second travel control. In the case where the second travel control is executed, the travel control unit 32 controls the working machine 10 so that the traveling speed Vc of the working machine 10 does not exceed the upper limit speed Vu. In the case where the second travel control is executed, the travel control unit 32 may control the working machine 10 so that the traveling speed Vc of the working machine 10 becomes the upper limit speed Vu. In this case, for example, in accordance with the gradual decrease in the upper limit speed Vu, the working machine 10 also inevitably decelerates gradually. It should be noted that the travel control unit 32 may accelerate or decelerate the working machine 10 as long as the traveling speed Vc does not exceed the upper limit speed Vu. For example, in the case where the above-described occupant performs the accelerator operation, the travel control unit 32 may accelerate the working machine 10 within a range equal to or less than the upper limit speed Vu while gradually lowering the upper limit speed Vu.

The travel control unit 32 may gradually lower the upper limit speed Vu based on the following Expression (3). In Expression (3), Vc, Vt, Dth1, and Dth2 conform to Expression (1) and Expression (2). Vu is the upper limit speed Vu. Dt is the distance Dt between the working machine 10 and the target point P. According to Expression (3), as the distance Dt between the working machine 10 and the target point P becomes closer to the second distance threshold Dth2, the upper limit speed Vu becomes closer t the target speed Vt.

$$\begin{matrix}[ Expression 3 ] & \\ Vu = \frac{( Vc - Vt )}{Dth 1 - Dth 2} \times ( Dt - Dth 2 ) + Vt & ( 3 )\end{matrix}$$

The third travel control is control for maintaining the upper limit speed Vu at the target speed Vt. In the case where the distance Dt between the working machine 10 and the target point P is less than the second distance threshold Dth2, the travel control unit 32 executes the third travel control. In the case where the third travel control is executed, the travel control unit 32 controls the working machine 10 so that the traveling speed Vc of the working machine 10 is equal to or less than the target speed Vt. The travel control unit 32 may accelerate or decelerate the working machine 10 as long as the traveling speed Vc does not exceed the target speed Vt.

Although the target speed Vt illustrated in FIG. 3 is greater than zero, the target speed Vt may be zero as described above. In this case, the upper limit speed Vu of the working machine 10 between the second distance threshold Dth2 and the target point P is maintained at zero by the third travel control. However, even if the upper limit speed Vu is set to zero, the actual traveling speed Vc of the working machine 10 does not immediately become zero. This is because a certain amount of control delay time Tfr occurs from when a control command for designating the traveling speed Vc is generated by the control device 18 (the computer) to when the traveling speed Vc designated by the control command is reflected in the actual behavior of the vehicle body 12. Therefore, even after the upper limit speed Vu is set to zero, the working machine 10 actually moves gently and can reach the target point P.

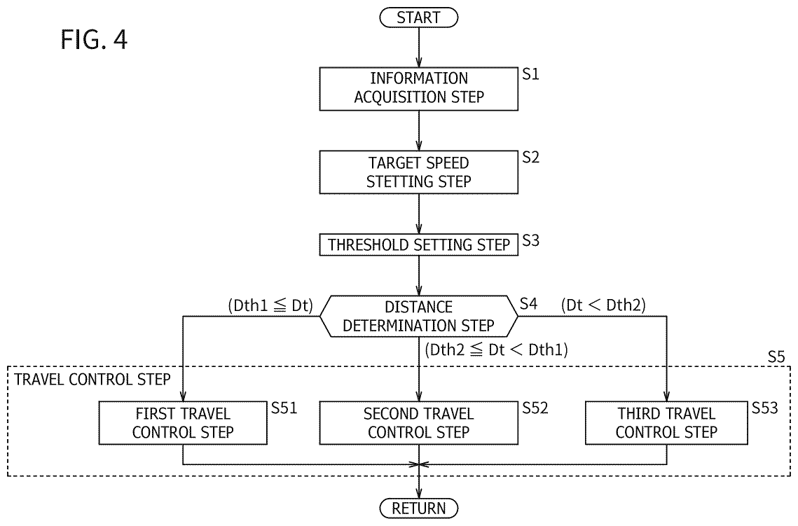

FIG. 4 is a flowchart of a control method according to the embodiment.

The control device 18 (the computer) described above can execute the control method of FIG. 4. This control method includes an information acquisition step S1, a target speed setting step S2, a threshold setting step S3, a distance determination step S4, and a travel control step S5.

In the information acquisition step S1, the information acquisition unit 24 acquires various types of information such as vehicle speed information, position information, and distance information.

In the target speed setting step S2, the target speed setting unit 26 sets the target speed Vt.

In the threshold setting step S3, the threshold setting unit 28 sets a plurality of distance thresholds Dth based on the traveling speed Vc of the working machine 10. More specifically, in the threshold setting step S3, the threshold setting unit 28 sets the plurality of distance thresholds Dth corresponding to differences between the vehicle speed information acquired in the information acquisition step S1 and the target speed Vt set in the target speed setting step S2.

In the distance determination step S4, the distance determination unit 30 compares the distance Dt between the working machine 10 and the target point P with the plurality of distance thresholds Dth.

The travel control step S5 includes a first travel control step S51, a second travel control step S52, and a third travel control step S53. The travel control unit 32 executes any one of the first travel control step S51, the second travel control step S52, or the third travel control step S53 based on the result of the comparison in the distance determination step S4.

In the case where the distance Dt between the working machine 10 and the target point P is equal to or greater than the first distance threshold Dth1 (Dth1≤Dt in FIG. 4), the first travel control step S51 is executed. In the first travel control step S51, the travel control unit 32 controls the vehicle body 12 based on the first travel control.

In the case where the distance Dt between the working machine 10 and the target point P falls within the range between the first distance threshold Dth1 and the second distance threshold Dth2 (Dth2≤Dt<Dth1 in FIG. 4), the second travel control step S52 is executed. In the second travel control step S52, the travel control unit 32 controls the vehicle body 12 based on the second travel control.

In the case where the distance Dt between the working machine 10 and the target point P is less than the second distance threshold Dth2 (Dt<Dth2 in FIG. 4), the third travel control step S53 is executed. In the third travel control step S53, the travel control unit 32 controls the vehicle body 12 based on the third travel control.

Thus, the control method of FIG. 4 is ended. The control method of FIG. 4 may be repeatedly executed according to a control cycle of the computation unit 22 (the processing circuitry) or the like. Note that the plurality of distance thresholds Dth are determined according to the traveling speed Vc of the working machine 10. Accordingly, the plurality of distance thresholds Dth change for each control cycle according to the change in the traveling speed Vc. Therefore, there may be a case where, for example, after the distance Dt is determined to be less than the first distance threshold Dth1 in the distance determination step S4 in a certain control cycle, the distance Dt is determined to be equal to or greater than the first distance threshold Dth1 in the distance determination step S4 in another control cycle. Similarly, there may be a case where, after the distance Dt is determined to be less than the second distance threshold Dth2 in the distance determination step S4 in a certain control cycle, the distance Dt is determined to be equal to or greater than the second distance threshold Dth2 in the distance determination step S4 in another control cycle. The travel control unit 32 appropriately selects any one of the first travel control step S51, the second travel control step S52, or the third travel control step S53 according to the result of the comparison in the distance determination step S4 in each control cycle.

The control device 18 (the control method) described above achieves the following operational effects, for example.

The control device 18 includes the travel control unit 32. The travel control unit 32 limits the upper limit speed Vu according to the distance Dt between the working machine 10 and the target point P. By changing the upper limit speed Vu according to the distance Dt between the working machine 10 and the target point P, the travel control unit 32 can realize route following with good accuracy while causing the working machine 10 to travel smoothly.

For example, in the case where the distance Dt between the working machine 10 and the target point P is equal to or greater than the first distance threshold Dth1, the working machine 10 is sufficiently far from the target point P. In this case, the travel control unit 32 allows the working machine 10 to travel at the first predetermined upper limit speed Vu1 based on the first travel control. As a result, the working machine 10 can move relatively quickly toward the target point P.

On the other hand, in the case where the distance Dt between the working machine 10 and the target point P is less than the first distance threshold Dth1, the working machine 10 is close to the target point P to some extent. In this case, the travel control unit 32 lowers the upper limit speed Vu to the target speed Vt (the second predetermined upper limit speed) based on the second travel control. As a result, the travel control unit 32 can cause the working machine 10 to travel at the traveling speed Vc at which the working machine 10 can stop at the target point P just enough or at the traveling speed Vc within a range in which the working machine 10 can perform the turnabout operation, the turning operation, and the like at the target point P with good accuracy.

In the case where the distance Dt between the working machine 10 and the target point P is less than the second distance threshold Dth2, the working machine 10 is further close to the target point P. In this case, the travel control unit 32 maintains the upper limit speed Vu at the target speed Vt (the second predetermined upper limit speed) based on the third travel control. As a result, the travel control unit 32 can cause the working machine 10 to travel at the traveling speed Vc at which the working machine 10 can stop at the target point P just enough or at the traveling speed Vc within a range in which the working machine 10 can perform the turnabout operation, the turning operation, and the like at the target point P with good accuracy.

The threshold setting unit 28 sets the plurality of distance thresholds Dth including the first distance threshold Dth1 and the second distance threshold Dth2 based on the traveling speed Vc of the working machine 10. As a result, the plurality of appropriate distance thresholds Dth are set.

The embodiment may be modified as described below. Note that description overlapping with that of the embodiment will be omitted as appropriate in the following description. Reference numerals given to the elements and concepts in the embodiment denote the same elements and concepts in the following description unless otherwise specified.

### (Modification 1)

Only in the case where the edge speed (the first predetermined upper limit speed Vu1) is equal to or greater than an edge speed threshold determined in advance, the travel control unit 32 may selectively use the plurality of travel controls according to the plurality of distance thresholds Dth.

### (Modification 2)

A speed different from the edge speed may be set as the first predetermined upper limit speed Vu1.

In relation to the above-described embodiment, the following supplementary notes are further disclosed.

### Supplementary Note 1

The control device (18) according to the present disclosure includes: the information acquisition unit (24) configured to acquire information indicating the distance (Dt) between the working machine (10) and the target point (P); and the travel control unit (32) configured to limit the upper limit (Vu) of the traveling speed (Vc) of the working machine according to the distance while controlling the working machine to cause the working machine to travel toward the target point.

### Supplementary Note 2

In the control device according to Supplementary Note 1, the travel control unit may execute the first travel control for setting the upper limit to the first predetermined upper limit speed (Vu1) in the case where the distance is equal to or greater than the first distance threshold (Dth1), and the travel control unit may execute the second travel control for lowering the upper limit to the second predetermined upper limit speed (Vt) that is lower than the first predetermined upper limit speed in the case where the distance falls within a range between the first distance threshold and the second distance threshold (Dth2) that is less than the first distance threshold.

### Supplementary Note 3

In the control device according to Supplementary Note 2, the travel control unit may set the second predetermined upper limit speed to zero in the case where the target point is a stop position of the working machine.

### Supplementary Note 4

In the control device according to Supplementary Note 2, the second predetermined upper limit speed may be settable to zero or more in the case where the target point is a turnabout point or a turning point of the working machine.

### Supplementary Note 5

In the control device according to Supplementary Note 2, in the case where the distance is less than the second distance threshold, the travel control unit may execute the third travel control for causing the working machine to reach the target point by setting the traveling speed to the second predetermined upper limit speed or less.

### Supplementary Note 6

The control device according to any one of Supplementary Notes 2 to 5 may further include the threshold setting unit (28) configured to set the first distance threshold and the second distance threshold according to the traveling speed, wherein the travel control unit may control the working machine based on the first distance threshold and the second distance threshold set by the threshold setting unit.

### Supplementary Note 7

The control method according to the present disclosure includes: the information acquisition step (S1) of acquiring information indicating the distance (Dt) between the working machine (10) and the target point (P); and the travel control step (S5) of limiting the upper limit (Vu) of the traveling speed (Vc) of the working machine according to the distance while controlling the working machine to cause the working machine to travel toward the target point.

Although the present disclosure has been described in detail, the present disclosure is not limited to the above-described individual embodiments. Various additions, replacements, modifications, partial deletions, and the like can be made to these embodiments without departing from the essence and gist of the present disclosure or without departing from the essence and gist of the present disclosure derived from the claims and equivalents thereof. Further, these embodiments can also be implemented in combination. For example, in the above-described embodiments, the order of operations and the order of processes are shown as examples, and are not limited to these. Furthermore, the same applies to a case where numerical values or mathematical expressions are used in the description of the above-described embodiments.

What is claimed is:

1. A control device comprising one or more processors that execute computer-executable instructions stored in a memory,
wherein the one or more processors execute the computer-executable instructions to cause the control device to:
acquire information indicating a distance between a working machine and a target point; and
limit an upper limit of a traveling speed of the working machine according to the distance while controlling the working machine to cause the working machine to travel toward the target point.

2. The control device according to claim 1, wherein
the one or more processors cause the control device to:
execute first travel control for setting the upper limit to a first predetermined upper limit speed in a case where the distance is equal to or greater than a first distance threshold; and
execute second travel control for lowering the upper limit to a second predetermined upper limit speed that is lower than the first predetermined upper limit speed in a case where the distance falls within a range between the first distance threshold and a second distance threshold that is less than the first distance threshold.

3. The control device according to claim 2, wherein
the one or more processors cause the control device to set the second predetermined upper limit speed to zero in a case where the target point is a stop position of the working machine.

4. The control device according to claim 2, wherein
the second predetermined upper limit speed is settable to zero or more in a case where the target point is a turnabout point or a turning point of the working machine.

5. The control device according to claim 2, wherein
in a case where the distance is less than the second distance threshold, the one or more processors cause the control device to execute third travel control for causing the working machine to reach the target point by setting the traveling speed to the second predetermined upper limit speed or less.

6. The control device according to claim 2, wherein
the one or more processors cause the control device to:
set the first distance threshold and the second distance threshold according to the traveling speed; and
control the working machine based on the first distance threshold and the second distance threshold that have been set.

7. A control method executed by one or more processors, the control method comprising:
acquiring information indicating a distance between a working machine and a target point; and
limiting an upper limit of a traveling speed of the working machine according to the distance while controlling the working machine to cause the working machine to travel toward the target point.
